(19) United States
(12) Patent Application Publication
(10) Pub. No.: US 2011/0222294 A1
(43) Pub. Date: Sep. 15, 2011

(54) Side emitting LED module

(75) Inventors: Yi-Hua Fan, Chung Li (TW); Rong-Jhe Chen, Chung Li (TW); Sheng-Kai Chang, Chung Li (TW)

(73) Assignee: Chung-Yuan Christian University, Tao-Yuan (TW)

(21) Appl. No.: 12/647,118

(22) Filed: Dec. 24, 2009

(30) Foreign Application Priority Data
Dec. 26, 2008 (TW) 097150812

(51) Int. Cl. F21V 7/00; F21V 5/00

(52) U.S. Cl. 362/296.01

(57) ABSTRACT

The invention provides a side emitting light emitting diode (LED) module which comprises a LED, a base, a lens, a reflex plane and a transparent plane wherein the base is on the LED for facing it, the lens placed on the base and is centered by the LED, the reflex plane is on the lens for refracting or transmitting lights from the lens reflexing, the outer is the transparent plane which is an extended plane from the rim of the reflex plane down to the base, both the refracting light by the reflex plane and the transmitting light by the lens sent out by the transparent plane, the final lights from the transparent plane parallel the base and sent out of the LED module.

### FIELD OF THE INVENTION

The present invention relates generally to a side emitting (or alternatively referring to as “side view”) light emitting diode (LED) module, more particularly to a light emitting diode with horizontal light ray irradiation.

### BACKGROUND OF THE INVENTION

A light-emitting diode (LED) carries many advantageous properties including mercury-free packaging, high purity in light colors, compact size, light weight, robust casing, low power consumption and greater lifespan which can meet the production requirements of the manufacturing industry with environmentally friendly awareness. Accordingly, potential applications of LEDs, these years, have drawn in much attention and been put through a wide variety of research. An LED itself enjoys use in applications, from, in the beginning, as diverse as indicator lamps of electronic appliances and traffic signals to replacements for traditional neon lighting in commercial signboards; further, in display devices, LEDs have become more popular to supersede the cold cathode fluorescent lamp (CCFL) as a light source in backlight modules. Recently, the adoption of LED headlights in the automotive industry has portended that LED lighting is going to get a big chunk of colossal lighting market share in an attempt to replace traditional lighting fixtures.

As to the LED application in the backlight module of a display device, two major types of the module are commonly seen in design: side-edge type and direct type in terms of illuminant locations. Liquid crystal display (LCD) panels are mainly used in notebook computers and LCD monitors which demand a lightweight, compact and thinner backlight module, and the side-edge LED design can accommodate the application requirements thereof, whereas the backlight module for a super-sized television set needs to put much emphasis on the qualities of sufficient luminance, wide viewing angles, high contrast and longer lifespan with which the direct backlight module has become a common design for large LCD screens.

FIG. 1A is an illustration of the transmission of light in the invention of U.S. Pat. No. 6,679,621 claimed by Philips Lumileds Lighting Company filed January, 2002, entitled “Side Emitting LED and Lens.” The direction of light transmission illustrated in FIG. 1A details that an inventive LED can make use of its structural design with total reflecting and refracting methods to serve as a side emitting light source. FIG. 1B is an illustration of the invention of U.S. Pat. No. 6,598,998, also claimed by Philips Lumileds Lighting Company filed January, 2003, entitled “Side Emitting Light Emitting Device.” The direction of light transmission illustrated in FIG. 1B further elaborates that the structural design in reflection and refraction of an LED noticeably makes more light emitted by the LED horizontally redirected to both the sides. However, the non-planar design of the transmittance surface somewhat impedes a small portion of the light from emitting through the transmittance surface, and it is not easy to manufacture the non-planar design of the transmittance surface.

In addition, the invention of R.O.C. Patent Ser. No. I256154 claimed by Coretronic Corporation filed June, 2006, discloses an edge emitting semiconductor light emitting component and a lens thereof (FIG. 1C). The light source of the light emitting component is mainly from an LED to achieve an edge emitting effect by means of light reflecting and refracting methods. In accordance with the disclosure of the I256154,the light of the LED is reflected by a reflection surface (or alternatively referred to as a reflex plane) and then emits through the transmittance surface in the horizontal direction. Total reflection in the horizontal direction is created while the incident light from the LED is reflected on the reflection surface; to avoid refraction while the light of total reflection emits through the transmittance surface, the light of total reflection is to perpendicularly enter the transmittance surface and exit the transmittance surface without refraction. FIG. 1C shows a sawtooth portion consisting of several miniature right-angular structures which is intended for making the light of total reflection from different angles perpendicularly enter the transmittance surface without refraction. Meanwhile, a small amount of the light of total reflection incident on the transmittance surface is refracted at the lower half of the transmittance surface to create refracted light in the horizontal direction.

All three said side/edge emitting LED inventions make good use of reflection and refraction to redirect light from LEDs in an effort to devise the inventive side/edge emitting LEDs applicable to being used in backlight modules of display devices. In the inventions, it is a prerequisite not to bring about refraction while having reflected light transmit directly through a transmittance surface even though a small amount of incident light is refracted in the transmittance surface to create refracted light in the horizontal direction transmitting through the transmittance surface together with the reflected light. The non-planar designs of the transmittance surfaces are to bring about both refraction and non-refraction within the transmittance surfaces; thus, in contrast with other inventions, it is much complicated to manufacture the transmittance surfaces.

On manufacturing an LED, directivity of the LED is set to an index, leaving us fewer options to meet the requirements of different radiation patterns in lighting. Further, performance of an LED oftentimes can not measure up to the design of a light module. Using LEDs right off the shelf to design a light module, all the parameters of the light module are surely to be defined according to the structural design of the LEDs. This, in turn, will lead to the lack of unity and consistency in module design. Besides, emitting angles of the LED light module can only be exploited correspondingly. Thus, it is hoped that emitting angles of side/edge emitting LEDs can be freely altered to meet designers' demands in a bid to step up the degree of freedom in designing an LED light module.

Considering the difficulties facing the invention patents and the related market, it is deemed necessary to devise a new lens structure of an LED to achieve the mass production goal of side/edge emitting LED modules, and to improve the ways of guiding light, cut down on production costs and meet the demands of the related market.

### SUMMARY OF THE INVENTION

In light of the above background, the present invention discloses a side emitting light emitting diode module which is able to effectively direct the light rays from a center light emitting diode to a direction perpendicular to the optic axis of the light emitting diode.

By a disclosed lens structure, light rays from the light emitting diode can be directed to concentrate along specific directions. In other words, the light rays can be focused at specific emitting angles. In one example, the light rays exit the disclosed emitting diode module nearly horizontally. The disclosed side emitting light emitting diode module can be applied in illumination devices, the backlight module of a liquid crystal display (LCD), etc.

In one embodiment of the present invention, a side emitting light emitting diode module is disclosed, which is capable of directing light rays from a light emitting diode to a designated direction. The disclosed module comprises a lens unit which comprises a bottom surface (or alternatively referred to as a base in other embodiments of the present invention), a first incidence surface, a second incidence surface, a third incidence surface, a (total) reflection surface (or alternatively referred to as a reflex plane in other embodiments of the present invention), and a transmittance surface. The bottom surface is arranged to face the light emitting diode. The lens unit is arranged to contact the light emitting diode via the bottom surface. The first incidence surface is arranged to be perpendicular to the bottom surface; a portion of the light rays from the light emitting diode enters the lens unit via the first incidence surface. The transmittance surface is arranged to form an angle with the bottom surface so as to let the light rays passing through the first incidence surface get refracted in such a way that the refracted light rays exit the lens unit along a direction perpendicular to the center axis/optic axis of the light emitting diode. The second incidence surface is selected to be a curved surface which centers at the point of light emission of light emitting diode. A portion of the light rays from the light emitting diode pass through the second incidence surface without being refracted; these light rays are directly projected to the reflection surface. The reflection surface is arranged to be symmetrical about the center axis/optic axis of the light emitting diode, and is selected to be a parabolic surface with its focus at the point of light emission of the light emitting diode. Such arrangement, combined with a selected angle between the transmittance surface and the bottom surface, enables the reflected light rays from the reflection surface to be refracted by the transmittance surface and then exit the lens unit in a direction perpendicular to the center axis/optic axis of the light emitting diode.

A little portion of the light rays from the light emitting diode is not able to project on the reflection surface due to physical limitation, and thus is not able to exit the transmittance surface along a direction perpendicular to the center axis/optic axis of the light emitting diode. Therefore, a third incidence surface is inserted between the first incidence surface and the second incidence surface to redirect these light rays to the reflection surface, so that they can be reflected (by the reflection surface) and refracted (by the transmittance surface) before exiting the disclosed lens unit, as other light rays from the light emitting diode do.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1A is an illustration of the transmission of light in the invention of U.S. Pat. No. 6,679,621.

FIG. 1B is an illustration of a side emitting diode disclosed in U.S. Pat. No. 6,598,998.

FIG. 1C is an illustration of an edge emitting semiconductor light emitting component and a lens thereof in the invention of R.O.C. Patent Ser. No. I256154.

FIG. 2 is an illustration of a side emitting light emitting diode module in accordance with an embodiment of the present invention.

FIG. 3A shows simulated angular distribution of the strength of illumination within a side emitting light emitting diode module without being configured in accordance with the present invention.

FIG. 3B shows simulated angular distribution of the strength of illumination within a side emitting light emitting diode module configured in accordance with the present invention.

FIG. 4A shows simulated angular distribution of the strength of illumination within a side emitting light emitting diode module without being configured according to the present invention.

FIG. 4B shows simulated angular distribution of the strength of illumination within a side emitting light emitting diode module configured in accordance with the present invention.

FIG. 5A shows simulated angular distribution of the strength of illumination within a side emitting light emitting diode module without being configured according to the present invention.

FIG. 5B shows simulated angular distribution of the strength of illumination within a side emitting light emitting diode module configured in accordance with the present invention.

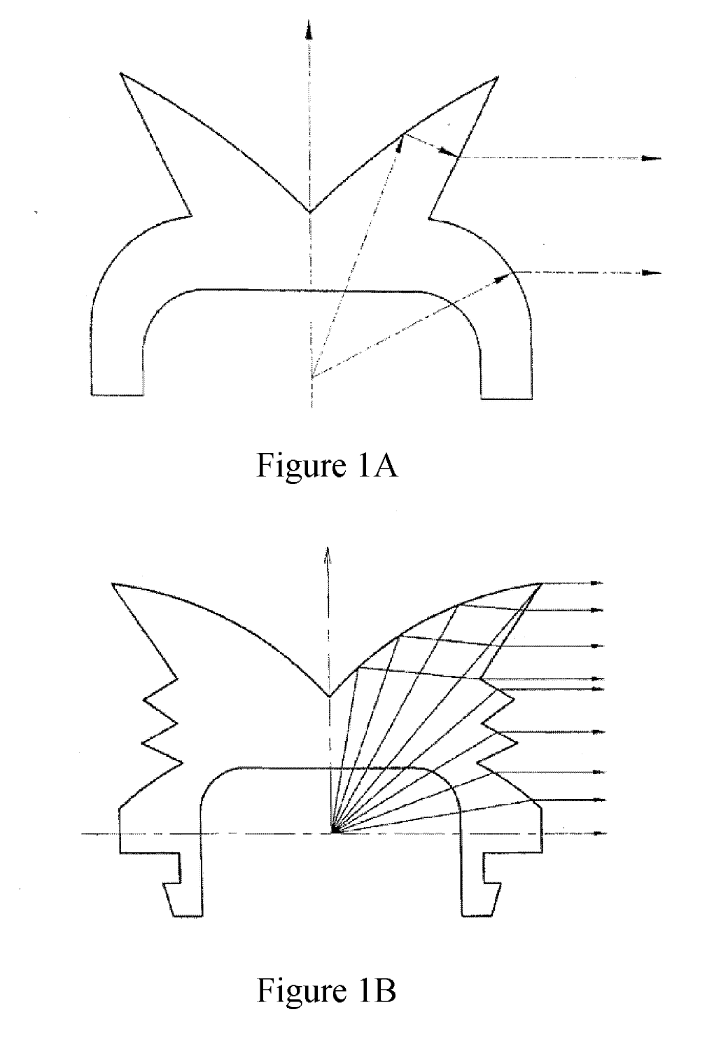

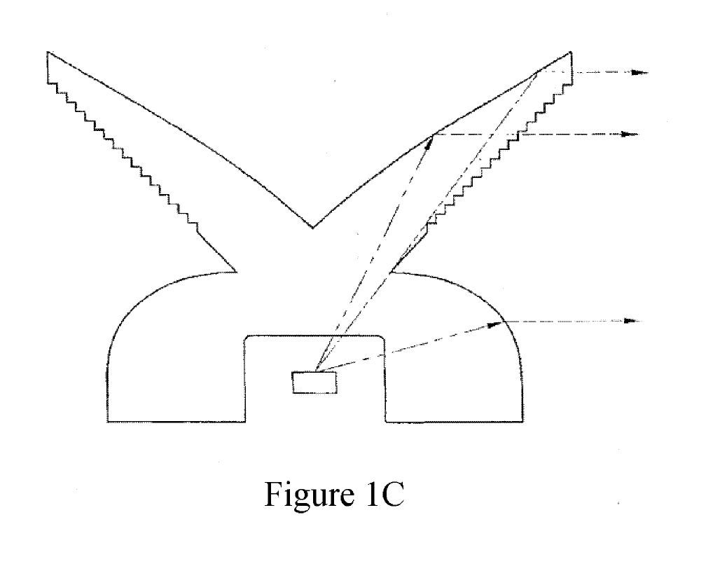

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

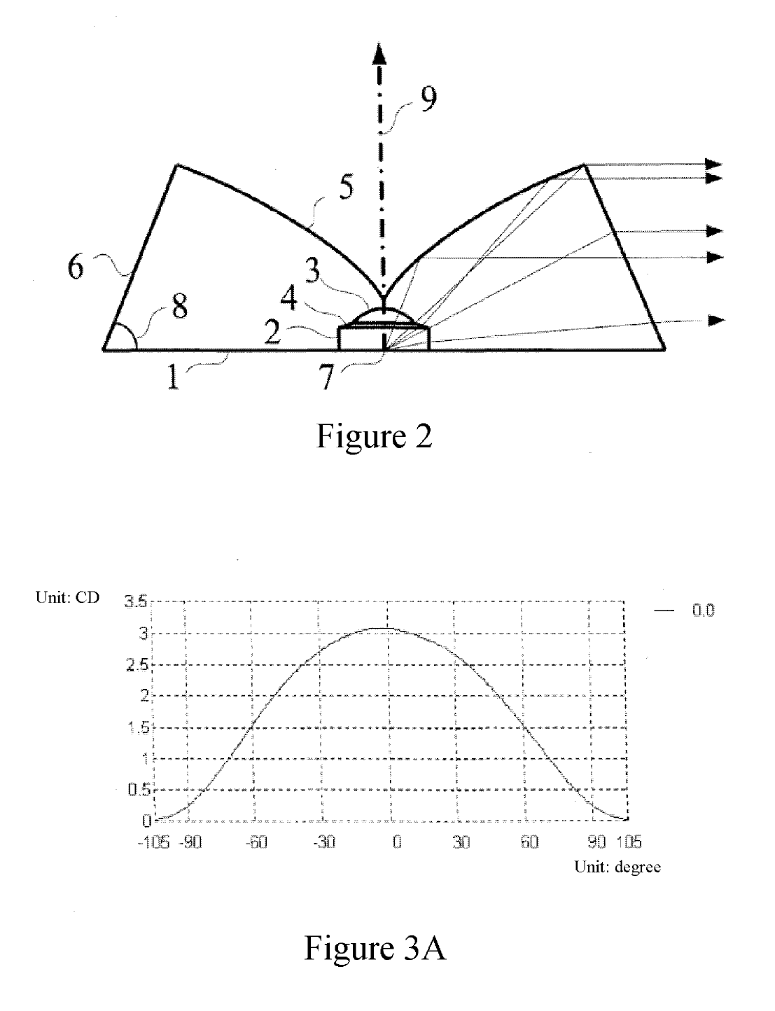

Reference is now made to FIG. 2, which is an illustration of a side emitting light emitting diode module in accordance with an embodiment of the present invention. As shown, the illustrated module comprises a bottom surface (or alternatively referred to as a base in other embodiments of the present invention) (1), a first incidence surface (2), a second incidence surface (3), a third incidence surface (4), a (total) reflection surface (or alternatively referred to as a reflex plane in other embodiments of the present invention) (5), a transmittance surface (or alternatively referred to as a transparent plane in other embodiments of the present invention) (6), and a light emitting diode (7). In one example, the reflection surface (5) is arranged on the second incidence surface (3), being symmetrical about a center axis/optic axis (9) of the light emitting diode (7), and extends outward therefore forming a parabolic surface with the focus at the point of light emission of the light emitting diode (7). The transmittance surface (6) extends, from the rim of the reflection surface (5), downward to connect to the bottom surface (1). The angle between the transmittance surface (6) and the bottom surface (1), which is indicated in the figure as (8), is smaller than 90 degrees, so as to let the light rays passing through the first incidence surface (2) pass through the transmittance surface (6) and get refracted in such a way that the refracted light rays exit the disclosed light emitting diode module along a direction perpendicular to the center axis (9).

Light rays from the light emitting diode (7) pass through the first incidence surface (2), the second incidence surface (3) and the third incidence surface (4), respectively. In one example, these three incidence surfaces are replaced by a lens assembly which comprises a three-layer structure with each corresponding to the first, second and third incidence surface, respectively. In such case, as the first incidence surface (2) is arranged to be perpendicular to the bottom surface (1), the bottom layer of the lens assembly can be a cylinder or a cuboid. The second incidence surface (3) of a top cambered body layer is selected to be a curved surface which centers at the point of light emission of the light emitting diode (7). A portion of the light rays from the light emitting diode (7) pass through the second incidence surface (3) without being refracted; these light rays are directly projected to the reflection surface (5) and get totally reflected. The reflection surface (5) is symmetric about the center axis/optic axis (9) and extends outward, forming a parabolic surface with its focus at the point of light emission of the light emitting diode (7). The totally reflected light rays from the reflection surface (5) is refracted by the transmittance surface (6) and then exits the disclosed light emitting diode module in a direction nearly perpendicular to the center axis/optic axis (9).

A little portion of the light rays from the light emitting diode (7) however, is not able to project on the reflection surface (5) due to physical limitation, and thus is not able to exit the disclosed light emitting diode module in a direction nearly perpendicular to the center axis/optic axis (9). Therefore, in this embodiment a third incidence surface (4) of a middle annular or ring-like body layer is inserted between the first incidence surface (2) and the second incidence surface (3) to redirect these light rays to the reflection surface (5), so that they can be reflected (by the reflection surface (5)) and refracted (by the transmittance surface (6)) before exiting the disclosed, as other light rays from the light emitting diode (7) do. It is noted that the transmittance surface (6) receives both totally reflected light rays from the reflection surface (5) and refracted light rays from the first incidence surface (2). These two groups of light rays hit the transmittance surface (6) at different angles and thus receive different degree of refraction. The light rays from the reflection surface (5) hit the transmittance surface (6) with a larger angle thus receive a greater degree of refraction, while the light rays from the first incidence surface (2) hit the transmittance surface (6) with a smaller angle and thus receive a smaller degree of refraction. But after passing through the transmittance (6), both groups of light rays exit the disclosed light emitting diode module in a direction nearly perpendicular to the center axis/optic axis (9).

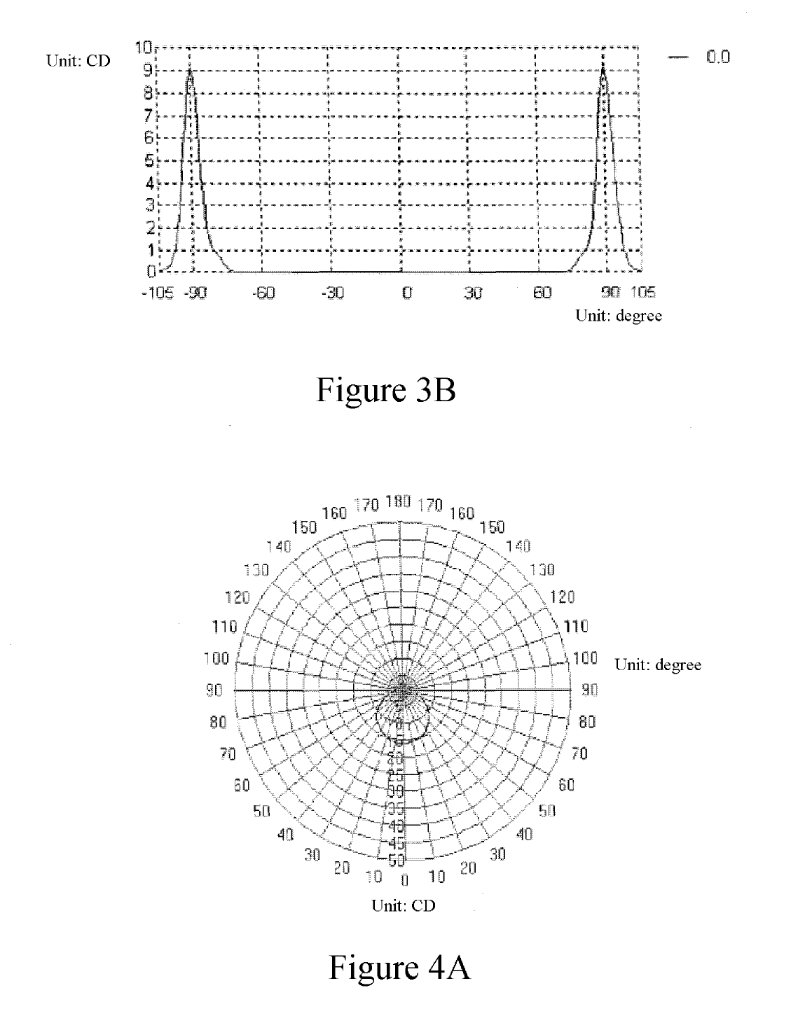

Reference is now made to FIG. 3A and 3B, which are illustrations of the simulation results of light transmission and angular distribution of the strength of illumination within a side emitting light emitting diode module. FIG. 3A shows the simulated angular distribution of the system illumination strength for a module without being configured in accordance with the present invention, and FIG. 3B shows the simulated angular distribution the system illumination strength for a module configured in accordance with the present invention. As shown, in FIG. 3A the luminance of the system has a bell-like distribution centering at the center axis/optic axis (9), with an upper bound of 3.5 candlepower. In FIG. 3B however, the luminance of the system reaches above 9 candlepower. This is mainly because with the configuration provided by the present invention, the light rays from the center light emitting diode (7) can exit the light emitting diode module in a direction at an angle of, for example, 85˜95° with the center axis/optic axis (9). As shown, the system illumination strength in the horizontal direction (the two sides of the system) exceeds 9 candlepower.

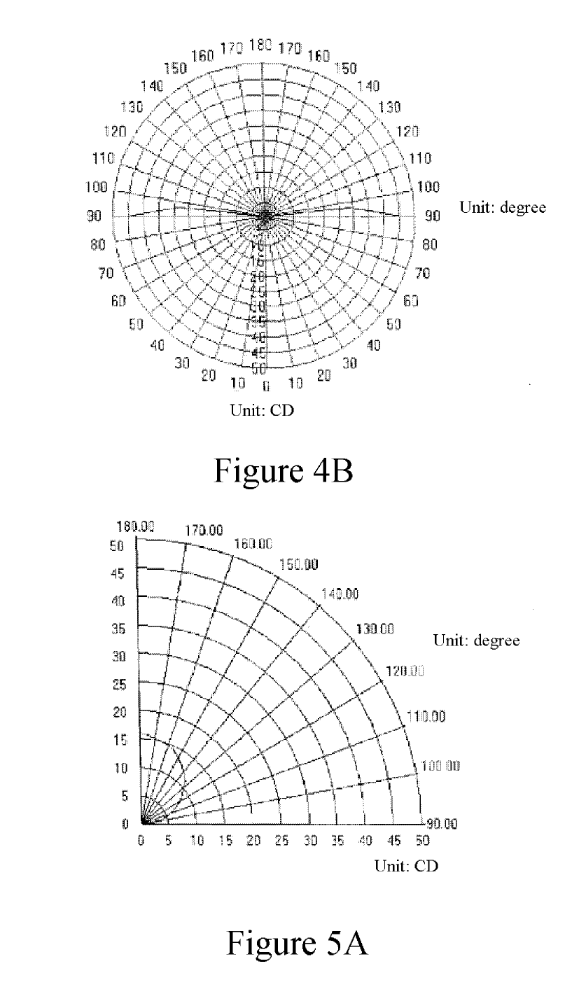

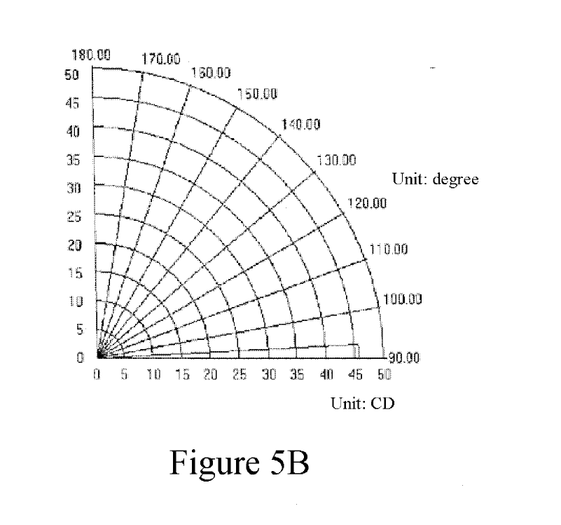

Other simulation results of angular distribution of the system illumination strength are shown in FIGS. 4 and 5. FIG. 4A and 5A show the simulation results for a module without being configured in accordance with the present invention, and FIG. 4B and 5B show the simulation results for a module configured in accordance with the present invention. It can be seen from these simulation results that the present invention discloses a method for configuring a side emitting light emitting diode module to have the highest strength of illumination at a specific angle which can be designated according to the application requirements. Further, the emitting angle of the system can be designed to be within a 5 degree range of the angle of highest illumination strength.

As a result, the directivity of the light emitting diode as the light source can be designed to be in line with that of the overall illuminating device. The emitting angle of the illuminating device is thus able to be designed with more flexibility, leading to a wider range of application possibilities. This result is useful not only to the scientific research but also the industrial applications.

The disclosed side emitting light emitting diode module can be applied in illuminating devices to render indirect illumination, thus effectively reducing glaring. In some example, the disclosed side emitting light emitting diode module can also be applied in the lighting of commercial signboards to render uniform illumination thus an improved effect of display. In other examples, the disclosed side emitting light emitting diode module are applied in the backlight module of liquid crystal display (LCD) devices.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A side emitting light emitting diode (LED) module, comprising:
a light emitting diode;
a bottom surface arranged to face said light emitting diode;
a first incidence surface arranged to be on and perpendicular to said bottom surface;
a second incidence surface arranged on said first incidence surface, said second incidence surface being a curved surface centering at said light emitting diode;
a third incidence surface, said third incidence surface serving as an extension of said first incidence surface and connecting to said second incidence surface;
a reflection surface arranged on said second incidence surface;
a transmittance surface extending from the rim of said reflection surface and downwards to connect to said bottom surface, the angle between said transmittance surface and said bottom surface being smaller than 70 degrees,
wherein said light emitting diode emits light rays which are projected via said first incidence surface to said transmittance surface and then refracted by said transmittance surface,
and wherein said refracted light rays are then projected via said second or third incidence surface to said reflection surface and then totally reflected by said reflection surface.

2. The side emitting light emitting diode module according to claim 1,
wherein said reflection surface is arranged to be perpendicular to said bottom surface,
and wherein said reflection surface is an outward-extending parabolic surface with said light emitting diode as a center axis/optic axis.

3. The side emitting light emitting diode module according to claim 1,
wherein a first refraction light ray is formed from said light emitting diode through refraction of light rays coming therefrom by said first incidence surface,
and wherein a first horizontal light ray is formed from said first refraction light ray through refraction thereof by said transmittance surface,
and wherein said first horizontal light ray is parallel to said bottom surface.

4. The side emitting light emitting diode module according to claim 1,
wherein a second refraction light ray is formed from said light emitting diode through refraction of light rays coming therefrom by said second incidence surface,
and wherein a first total-reflection light ray is formed from said second refraction light ray through total reflection thereof by said reflection surface,
and wherein a second horizontal light ray is formed from said first total-reflection light ray through refraction thereof by said transmittance surface,
and wherein said second horizontal light ray is parallel to said bottom surface.

5. The side emitting light emitting diode module according to claim 1,
wherein a third refraction light ray is formed from said light emitting diode through refraction of light rays coming therefrom by said third incidence surface,
and wherein a second total-reflection light ray is formed from said third refraction light ray through total reflection thereof by said reflection surface,
and wherein a third horizontal light ray is formed from said second total-reflection light ray through refraction thereof by said transmittance surface,
and wherein said third horizontal light ray is parallel to said bottom surface.

6. The side emitting light emitting diode module according to claim 5, wherein a fourth horizontal light ray is formed from said third refraction light ray through refraction thereof at the location of critical angle of the joint edges of said total reflection surface and said transmittance surface,
and wherein said fourth horizontal light ray is parallel to said bottom surface.

7. A side emitting light emitting diode module, comprising:
a light emitting diode;
a bottom surface arranged to face said light emitting diode;
a lens arranged on said bottom surface centering at said light emitting diode, said lens having a three-layer structure of a bottom cylinder body layer, a middle ring-like body layer, and a top cambered body layer;
a reflection surface arranged on said lens for reflecting refracted or transmitted light rays from said lens; and
a transmittance surface arranged to extend from the rim of said reflection surface downwards to connect to said bottom surface,
wherein reflected light rays from said reflection surface pass through said transmittance surface.

8. The side emitting light emitting diode module according to claim 7,
wherein said reflection surface is arranged to be perpendicular to said bottom surface,
and wherein said reflection surface is an outward-extending parabolic surface with said light emitting diode as its center axis/optic axis.

9. The side emitting light emitting diode module according to claim 7, wherein the angle between said transmittance surface and said bottom surface is smaller than 70 degrees.

10. The side emitting light emitting diode module according to claim 7, wherein said cambered body centers at said light emitting diode.

11. The side emitting light emitting diode module according to claim 7,
wherein a first refraction light ray is formed by light rays from said light emitting diode passing through said cambered body,
and wherein a first total-reflection light ray is formed from said first refraction light ray through total reflection thereof by said reflection surface.

12. The side emitting light emitting diode module according to claim 11,
wherein a first horizontal light ray is formed from said first total-reflection light ray through refraction thereof by said transmittance surface,
and wherein said first horizontal light ray is parallel to said bottom surface.

13. The side emitting light emitting diode module according to claim 7,
wherein a second refraction light ray is formed by light rays from said light emitting diode passing through said cylinder body,
and wherein a second total-reflection light ray is formed from said second refraction light ray through total reflection thereof by said reflection surface.

14. The side emitting light emitting diode module according to claim 13,
wherein a second horizontal light ray is formed from said second total-reflection light ray through refraction thereof by said transmittance surface,
and wherein said second horizontal light ray is parallel to said bottom surface.

15. The side emitting light emitting diode module according to claim 7,
wherein a third refraction light ray is formed by light rays from said light emitting diode passing through said ring-like body,
and wherein a third horizontal light ray is formed from said third refraction light ray through refraction thereof by said transmittance surface,
and wherein said third horizontal light ray is parallel to said bottom surface.

16. The side emitting light emitting diode module according to claim 7,
wherein a third refraction light ray is formed by light rays from said light emitting diode passing through said ring-like body,
and wherein a fourth horizontal light ray is formed from said third refraction light ray through refraction thereof at the location of critical angle of the joint edges of said reflection surface and said transmittance surface,
and wherein said fourth horizontal light ray is parallel to said bottom surface.

17. A side emitting light emitting diode module, comprising:
a light emitting diode;
a bottom surface arranged to face said light emitting diode;
a lens arranged on said bottom surface centering at said light emitting diode, said lens having a three-layer structure with a bottom cuboid body layer, a middle ring-like body layer, and a top cambered body layer;
a reflection surface arranged on said lens for reflecting refracted or transmitted light rays from said lens; and
a transmittance surface arranged to extend from the rim of said reflection surface downwards to connect to said bottom surface,
wherein reflected light rays from said reflection surface pass through said transmittance surface.

18. The side emitting light emitting diode module according to claim 17,
wherein said reflection surface is arranged to be perpendicular to said bottom surface,
and wherein said reflection surface is an outward-extending parabolic surface with said light emitting diode as its center axis/optic axis.

19. The side emitting light emitting diode module according to claim 17, wherein the angle between said transmittance surface and said bottom surface is smaller than 70 degrees.

20. The side emitting light emitting diode module according to claim 17, wherein said cambered body centers at said light emitting diode.

21. The side emitting light emitting diode module according to claim 17,
wherein a first refraction light ray is formed by light rays from said light emitting diode passing through said cambered body,
and wherein a first total-reflection light ray is formed from said first refraction light ray through total reflection thereof by said reflection surface.

22. The side emitting light emitting diode module according to claim 21,
wherein a first horizontal light ray is formed from said first total-reflection light ray through refraction thereof by said transmittance surface,
and wherein said first horizontal light ray is parallel to said bottom surface.

23. The side emitting light emitting diode module according to claim 17,
wherein a second refraction light ray is formed by light rays from said light emitting diode passing through said cuboid body,
and wherein a second total-reflection light ray is formed from said second refraction light ray through total reflection thereof by said reflection surface.

24. The side emitting light emitting diode module according to claim 23,
wherein a second horizontal light ray is formed from said second total-reflection light ray through refraction thereof by said transmittance surface,
and wherein said second horizontal light ray is parallel to said bottom surface.

25. The side emitting light emitting diode module according to claim 17,
wherein a third refraction light ray is formed by light rays from said light emitting diode passing through said ring-like body,
and wherein a third horizontal light ray is formed from said third refraction light ray through refraction thereof by said transmittance surface,
and wherein said third horizontal light ray is parallel to said bottom surface.

26. The side emitting light emitting diode module according to claim 17,
wherein a third refraction light ray is formed by light rays from said light emitting diode passing through said ring-like body,
and wherein a fourth horizontal light ray is formed from said third refraction light ray through refraction thereof at the location of critical angle of the joint edges of said total reflection surface and said transmittance surface,
and wherein said fourth horizontal light ray is parallel to said bottom surface.
